(19) United States
(12) Patent Application Publication
(10) Pub. No.: US 2021/0311291 A1
(43) Pub. Date: Oct. 7, 2021

(54) OBJECTIVE LENS, OPTICAL HEAD DEVICE, OPTICAL INFORMATION APPARATUS, OPTICAL DISK SYSTEM, AND METHOD FOR INSPECTING OBJECTIVE LENS

(71) Applicant: Panasonic Intellectual Property Management Co., Ltd., Osaka (JP)

(72) Inventors: Yoshiaki KOMMA, Osaka (JP); Yuichi TAKAHASHI, Nara (JP)

(21) Appl. No.: 17/346,813

(22) Filed: Jun. 14, 2021

Related U.S. Application Data
(63) Continuation of application No. PCT/JP2020/042740, filed on Nov. 17, 2020.

(30) Foreign Application Priority Data
Apr. 3, 2020 (JP) 2020-067174

(51) Int. Cl. G02B 19/00

(52) U.S. Cl. CPC G02B 19/0052; G02B 19/0009

(57) ABSTRACT

This objective lens has a single lens that has a numerical aperture of 0.85 or more. A base material thickness th and a base material thickness tm differ from each other. The base material thickness th is a thickness where third-order spherical aberration is minimized when a light beam that is substantially parallel is input to the objective lens, and the base material thickness tm is a thickness where total aberration is minimized when third-order spherical aberration is minimized by changing parallelism of the light beam input to the objective lens from a parallel state.

### TECHNICAL FIELD

The present invention relates to an optical head device and an optical information apparatus that record and reproduce or erase information stored on an optical information medium such as an optical disk, a recording and reproducing method in the optical information apparatus, an optical disk system to which they are applied, and an objective lens used in the optical head device.

### BACKGROUND ART

An optical memory technology using an optical disk having a pitted pattern as a high-density and large-capacity storage medium has been put into practical application for various uses such as digital audio disks, video disks, document file disks, and data files. Functions of successfully performing recording and reproduction of information on and from an optical disk with high reliability using sharply focused light beam are roughly classified into a converging function to form a diffraction-limited micro spot, focus control (focus servo) and tracking control of an optical system, and pit signal (information signal) detection.

In recent years, development of an optical disk having a high-density storage capacity higher than that of a conventional optical disk has progressed due to advancement of optical system design technology and shortening of a wavelength of a semiconductor laser as a light source. As an approach to increase the density, increasing an optical-disk-side numerical aperture (hereinafter referred to as NA) of a light collection optical system that focuses a light beam on an optical disk has been studied.

With the expansion of the Internet, data to be created and accumulated in the world continues to increase. The importance of the optical disk as a medium for storing the data safely for a long period of time and with low power consumption is increasing. Therefore, it is necessary to increase the capacity of the optical disk to enable accumulation of more information in the optical disk. To this end, it is desirable to further increase the NA of an objective lens. An example in which an objective lens having a high NA is achieved by a single lens configuration has been proposed (see, for example, PTLs 1 and 2).

Further, in order to increase an information capacity per optical disk, a multilayer disk including more recording layers has been studied.

When the distance between a recording layer for signal reproduction and the adjacent recording layer is small in the multilayer disk, unnecessary reflected light from the adjacent recording layer enters a signal detector through an optical path which is nearly the same as an optical path of signal light. For this reason, if several factors such as unnecessary light being relatively strong are combined when a recording layer having a lower reflectance is reproduced, the unnecessary light interferes with a reproduction signal on the signal detector, which may cause signal disturbance. In order to avoid this problem, a multilayer disk structure having a wider distance between adjacent recording layers is preferable. However, when the thicknesses of the innermost recording layer and the surface are increased in order to increase the distance between recording layers, the disturbance (aberration) of light due to an inclination of disk increases, so that the recording and reproducing characteristics are deteriorated. Therefore, it is effective to reduce the thicknesses of the nearest layer and the surface (the thickness of a cover layer).

Regarding an objective lens that performs recording and reproduction by focusing light on a recording layer of an optical disk to a diffraction limit, the higher the numerical aperture, the more sharply it can focus light. Blu-ray (registered trademark) uses a numerical aperture of 0.85. In order to further increase the recording density, it is preferable to set the numerical aperture to 0.9 or more. For example, if the numerical aperture is intended to be set to 0.91, it is desirable to set the numerical aperture of the objective lens to about 0.92 or more in consideration of an allowance of displacement between the center of an aperture limit (aperture) used to improve the accuracy of the numerical aperture and the center of the objective lens. In order to manufacture such an objective lens having a high numerical aperture with high accuracy, it is desirable to input a substantially parallel light beam to the objective lens, focus the light beam by the objective lens, and perform measurement to check whether or not a convergent spot is focused without aberration.

As illustrated in FIG. 9, objective lens 561 for optical disk needs to focus light on recording surface (401a, 401b, 401c, 401d) through transparent base materials t1 to t4 of optical disk 401. Only one kind of a reference base material thickness at which third-order spherical aberration is minimized upon incidence of substantially parallel light beam 701 can be selected for one objective lens. In order to reduce the third-order spherical aberration for a base material thickness different from the reference base material thickness, a light beam entering the objective lens is converted into non-parallel light beam by changing the parallelism of the light beam in an optical system of an optical pickup. In that case, fifth-order spherical aberration which is higher-order spherical aberration occurs. PTL 3 discloses an objective lens that satisfies tc>(t0+te)/2, where tc is a base material thickness at which third-order spherical aberration is minimized upon incidence of a substantially parallel light beam, t0 is the largest base material thickness, and te is the smallest base material thickness. In FIG. 9, t0=t1+t2+t3+t4 and te=t1 are satisfied. In addition, PTL 4 discloses an objective lens in which an absolute value of a variation of fifth-order spherical aberration generated when third-order spherical aberration is corrected with respect to the largest base material thickness and an absolute value of a variation of fifth-order spherical aberration generated when third-order spherical aberration is corrected with respect to the smallest base material thickness are equal to each other as a method for determining a reference base material thickness at which the third-order spherical aberration is minimized upon incidence of a substantially parallel light beam. PTL 5 discloses an objective lens in which spherical aberration when a substantially parallel light beam enters the objective lens is minimized with respect to a base material thickness which is 85% to 110% of the largest base material thickness. In the manner described above, a generated amount of aberration is suppressed by designing an objective lens such that, when a substantially parallel light beam enters the objective lens, the third-order spherical aberration and the fifth-order spherical aberration are simultaneously minimized at a base material thickness which is substantially an average of base material thickness of an optical disk to which data is to be recorded or reproduced.

### CITATION LIST

### Patent Literatures

PTL 1: Unexamined Japanese Patent Publication No. 2003-279851

PTL 2: Unexamined Japanese Patent Publication No. 2008-293633

PTL 3: WO 2010/047093 A

PTL 4: WO 2008/149522 A

PTL 5: WO 2011/065276 A

### SUMMARY

As described above, it is effective in a multilayer disk to widen the distance between recording layers by reducing the thickness of the nearest layer and the thickness of the surface (the thickness of the cover layer). As a conventional optical disk, there is BDXL as a commercially available multilayer optical disk. There are two types of BDXL: three-layer disk, and four-layer disk. In the three-layer disk, the smallest base material thickness is 57 μm, and the largest base material thickness is 100 μm as standard of the base material thickness. In the four-layer disk, the smallest base material thickness is 53.5 μm, and the largest base material thickness is 100 μm as standard of the base material thickness. The average of the smallest base material thickness and the largest base material thickness is 78.5 μm for the three-layer disk and 76.75 μm for the four-layer disk. Therefore, the objective lens corresponding to these disks will be designed to have reference base material thickness to of 75 μm to 80 μm. During measurement of aberration, it is necessary to pass convergent light by the objective lens through the base material having thickness ta.

On the other hand, as described in the background art, it is desirable to increase the distance between recording layers in order to avoid a decrease in signal quality due to unnecessary reflected light between adjacent recording layers. We considered that, in a structure shown in FIG. 1 of an optical disk having four recording surfaces, for example, a structure having a base material thickness in which the standard value of the thickness of the cover layer is set to 46 μm and the standard value of the smallest distance between recording layers is set to 14 μm is desirable. This approach leads to an improvement in the noise-to-signal ratio of a reproduction signal, and thus is highly effective particularly when the recording density is increased to increase the capacity of the optical disk. In FIG. 1, optical disk 40 includes first information recording surface 40a, second information recording surface 40b, third information recording surface 40c, and fourth information recording surface 40d in order from a side closer to surface 40z.

Optical disk 40 further includes cover layer 42, first intermediate layer 43, second intermediate layer 44, and third intermediate layer 45. Thickness t1 of cover layer 42 represents the thickness of the base material between surface 40z and first information recording surface 40a, thickness t2 of first intermediate layer 43 represents the thickness of the base material between first information recording surface 40a and second information recording surface 40b, thickness t3 of second intermediate layer 44 represents the thickness of the base material between second information recording surface 40b and third information recording surface 40c, and thickness t4 of third intermediate layer 45 represents the thickness of the base material between third information recording surface 40c and fourth information recording surface 40d.

Further, a distance from surface 40z to first information recording surface 40a is d1 (≈t1), a distance from surface 40z to second information recording surface 40b is d2 (≈t1+t2), a distance from surface 40z to third information recording surface 40c is d3 (≈t1+t2+t3), and a distance from surface 40z to fourth information recording surface 40d is d4 (≈t1+t2+t3+t4). These are referred to as base material thicknesses.

The objective lens corresponding to the four-layer disk in FIG. 1 in which the average of base material thicknesses L0 and L3 is 73 μm will be designed such that reference base material thickness tb is between 70 μm to 75 μm according to the related arts disclosed in previously described PTLs 3 to 5. During measurement of aberration of the objective lens corresponding to this disk, it is necessary to pass convergent light by the objective lens through the base material with thickness tb.

On the other hand, as described above, in commercially available BDXL, the average of base material thicknesses L0 and L2 of a three-layer disk is 78.5 μm, and the average of base material thicknesses of L0 and L2 of a four-layer disk is 76.75 μm. Therefore, the objective lens corresponding to these disks will be designed such that reference base material thickness ta is between 75 μm to 80 μm. During measurement of aberration, it is necessary to pass convergent light by the objective lens through the base material having thickness ta. When this conventional objective lens is applied to an optical disk having a smaller base material thickness, there arises a problem that fifth or higher-order spherical aberration is increased too much. FIG. 10 is a characteristic diagram of a conventional objective lens optimally designed for a base material thickness of about 80 μm. Spherical aberration is minimized when a substantially parallel light beam is input to the objective lens and passed through a base material thickness of about 80 μm. In FIG. 10, the horizontal axis represents base material thickness, and the vertical axis represents aberration. For the thicknesses other than about 80 μm in the horizontal axis, the parallelism of the light beam input to the objective lens is changed to mainly reduce the third-order spherical aberration. However, there is a problem that, in a base material thickness other than about 80 μm in the horizontal axis, higher-order spherical aberration remains, and residual aberration particularly on a smaller base material thickness side remarkably increases. Aberration of 15 mλ (that is an rms value, and λ is a wavelength) remains at a base material thickness of 46 μm. Although such aberration is not large enough to impair recording and reproducing performance, margins such as a manufacturing error and a parallelism adjustment error of incident light are reduced. Considering that only 10 mλ of aberration remains at 100 μm which is on a larger base material thickness side, it must be said that an unbalanced state is established. Therefore, it is not desirable to use the conventional objective lens as it is for an optical disk in which the cover layer is thinned to, for example, 46 μm.

As described above, when reference base material thickness to where aberration is measured by inputting a substantially parallel light beam to the conventional objective lens corresponding to BDXL and reference base material thickness tb where aberration is measured by inputting a substantially parallel light beam to an objective lens corresponding to a novel four-layer disk are different from each other, it is necessary to measure aberrations of the respective objective lenses by passing the light beams through different base material thicknesses. Therefore, replacement of the base material is needed for inspection of each objective lens. Since the inclination of the base material causes coma aberration, it is necessary to accurately adjust the base material to be perpendicular to the optical axis. The base material needs to be adjusted to have a tolerance of 0.05° or less, preferably 0.01°. As described above, since inclination adjustment with high accuracy is required, there is a problem that replacement of the base material imposes a large burden in terms of time in the measurement step.

In order to address the abovementioned problems, the present invention provides an objective lens, an optical head device, an optical information apparatus, and an optical disk system which will be described below. In addition, the objective lens is inspected by the following measurement method.

(1) An objective lens having a single lens that has a numerical aperture (NA) of 0.85 or more, wherein base material thickness th where third-order spherical aberration is minimized when a substantially parallel light beam is input to the objective lens and base material thickness tm where total aberration is minimized when third-order spherical aberration is minimized by changing parallelism of the light beam input to the objective lens from a parallel state differ from each other.

(2)

The objective lens according to (1),

wherein base material thickness th is larger than base material thickness tm.

(3)

The objective lens according to (2),

wherein base material thickness th is larger than 75 μm, and base material thickness tm is smaller than 75 μm.

(4)

An objective lens having a single lens that has a numerical aperture (NA) of 0.85 or more, wherein base material thickness th where third-order spherical aberration is minimized when a substantially parallel light beam is input to the objective lens and base material thickness tm5 where fifth-order spherical aberration is minimized when third-order spherical aberration is minimized by changing parallelism of the light beam input to the objective lens from a parallel state differ from each other.

(5)

The objective lens according to (4),

wherein base material thickness th is larger than base material thickness tm5.

(6)

The objective lens according to (5),

wherein base material thickness th is larger than 75 μm, and base material thickness tm5 is smaller than 75 μm.

(7)

The objective lens according to any one of (1) to (6),

wherein the numerical aperture (NA) is 0.9 or more.

(8)

An optical head device comprising: a laser light source that emits a light beam; the objective lens according to any one of (1) to (7) that receives the light beam emitted from the laser light source and focuses the light beam on a micro spot on a recording surface of an optical disk; and a photodetector provided with an optical detector that receives the light beam reflected on the recording surface of the optical disk and outputs an electric signal according to an amount of the reflected light beam.

(9)

An optical information apparatus comprising:

the optical head device according to (8);

a motor that rotates an optical disk; and

an electric circuit that receives a signal obtained from the optical head device and controls and drives the motor, the objective lens, and the laser light source.

(10)

An optical information apparatus comprising:

an optical head device;

a motor that rotates an optical disk; and

an electric circuit that receives a signal obtained from the optical head device and controls and drives the motor, the objective lens, and the laser light source,

wherein the optical head device includes a first light source, the objective lens according to any one of claims 1 to 7 that receives a light beam emitted from the first light source and focuses the light beam on a micro spot on a recording surface of the optical disk through a base material with base material thickness t1, a photodetector provided with an optical detector that receives the light beam reflected on the recording surface of the optical disk and outputs an electric signal according to an amount of the reflected light beam, and an actuator that drives the objective lens in an optical axis direction to bring the micro spot into focus on the recording surface of the optical disk,

detects an electric signal for detecting a focal error signal from the photodetector, and

drives the objective lens in the optical axis direction by the actuator to bring the micro spot into focus on the recording surface of the optical disk.

(11)

An optical disk system comprising:

the optical information apparatus according to (9) or (10);

an input device or input terminal for inputting information;

a computing device that performs computation on the basis of information input from the input device or input terminal or information reproduced from the optical information apparatus; and

an output device or output terminal that displays or outputs the information input from the input device or input terminal, the information reproduced from the optical information apparatus, or a result computed by the computing device.

(12)

An optical disk system comprising:

the optical information apparatus according to (9) or (10); and

an information-to-image decoder that converts an information signal obtained from the optical information apparatus into an image.

(13)

An optical disk system comprising:

the optical information apparatus according to (9) or (10); and an image-to-information encoder that converts an image information obtained from the optical information apparatus into information to be recorded.

(14)

An optical disk system comprising:

the optical information apparatus according to (9) or (10); and an input and output terminal that exchanges information with an outside.

(15)

A method for inspecting an objective lens, the method comprising: measuring aberration when a substantially parallel light beam is input to an objective lens and passed through a fixed base material thickness; and determining a condition that a difference between total aberration and a refence value, or a difference between fifth-order spherical aberration and the refence value falls within a fixed range as a condition for a good product.

(16)

A method for inspecting the objective lens according to any one of (1) to (7), the method comprising: measuring aberration when a substantially parallel light beam is input to the objective lens and passed through a fixed base material thickness; and determining a condition that a difference between total aberration and a refence value, or a difference between fifth-order spherical aberration and the refence value falls within a fixed range as a condition for a good product.

The objective lens according to the exemplary embodiments of the present invention enables recording and reproduction of information to and from a high-density large-capacity optical disk having multiple recording layers, can share an inspection process with a conventional objective lens, and can be manufactured at low cost.

### BRIEF DESCRIPTION OF DRAWINGS

FIG. 1 is a diagram illustrating a schematic configuration of an optical disk according to a first exemplary embodiment of the present invention.

FIG. 2 is a configuration diagram of an objective lens according to the first exemplary embodiment of the present invention.

FIG. 3 is a diagram illustrating wavefront aberration of the objective lens according to Example 1.

FIG. 4 is a diagram illustrating wavefront aberration of an objective lens according to Example 2.

FIG. 5 is a diagram illustrating a configuration of an optical head device according to a second exemplary embodiment of the present invention.

FIG. 6 is a diagram illustrating a configuration of an optical information apparatus according to a third exemplary embodiment of the present invention.

FIG. 7 is a diagram illustrating a configuration of an optical disk system according to a fourth exemplary embodiment of the present invention.

FIG. 8 is a diagram illustrating a configuration of an optical disk system according to a fifth exemplary embodiment of the present invention.

FIG. 9 is a diagram illustrating a schematic configuration of a conventional optical disk.

FIG. 10 is a diagram illustrating wavefront aberration of a conventional objective lens.

### DESCRIPTION OF EMBODIMENTS

Exemplary embodiments will be described in detail below with reference to the drawings as appropriate. However, descriptions in more detail than necessary may be omitted. For example, detailed descriptions of matters which have already been well known in the art and redundant descriptions of substantially the same configurations will sometimes be omitted. Such omissions are for preventing following description from becoming redundant more than necessary, and for helping those skilled in the art easily understand the following description.

Note that the accompanying drawings and the following description are provided to help those skilled in the art to fully understand the present disclosure and are not intended to limit the subject matter recited in the appended claims.

### First Exemplary Embodiment

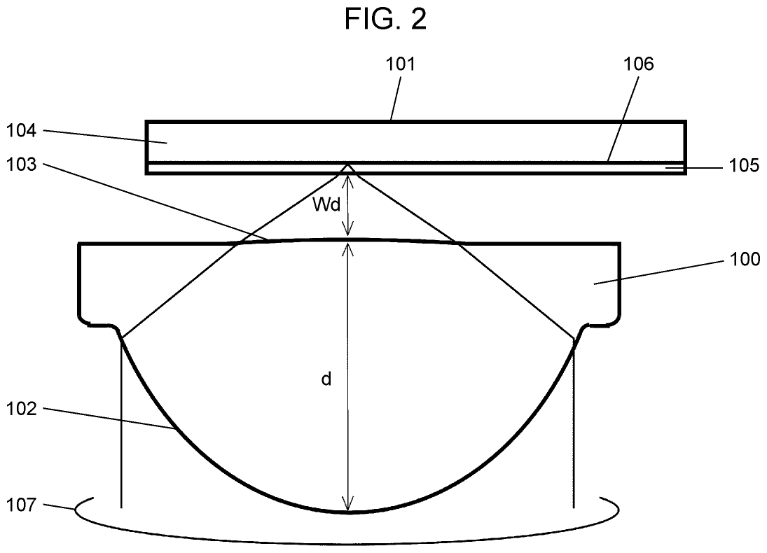

FIG. 2 is a configuration diagram of objective lens 100 according to a first exemplary embodiment of the present invention. In FIG. 2, objective lens 100 has first surface 102 that is a surface receiving an incident light beam, and second surface 103 that is a surface facing first surface 102. Optical disk 101 includes substrate 104, base material 105, and information recording surface 106 sandwiched between substrate 104 and base material 105. Light beam 107 enters first surface 102 of objective lens 100, passes through second surface 103, and converges on information recording surface 106 of optical disk 101. Here, the distance between second surface 103 and the surface (lower surface in FIG. 2) of base material 105 of optical disk 101 in a state where light beam 107 is converged on information recording surface 106 is referred to as a working distance (hereinafter referred to as Wd). In addition, a distance between first surface 102 and second surface 103 of objective lens 100 in the optical axis is defined as d.

### EXAMPLES

Specific exemplary embodiments of the present invention will be described in more detail with reference to examples. The following reference numerals are common in each Example. In addition, the designed wavelength λ is 405 nm, and the refractive index of the objective lens is around 1.623918.

f: focal length of objective lens

NA: NA of objective lens

R1: radius of curvature of first surface of objective lens

R2: radius of curvature of second surface of objective lens

d: lens thickness of objective lens

n: refractive index of objective lens

Wd: distance from second surface of objective lens to optical disk

Note that NA and refractive index have no units, and other parameters have a unit of mm.

In addition, the aspherical shape is given by the following (Equation 1).

$$X = \frac{{C}_{j} {h}^{2}}{1 + \sqrt{1 - ( 1 + {k}_{j} ) {C}_{j}^{2} {h}^{2}}} + \sum {A}_{j , n} {h}^{n} \qquad [ Equation 1 ]$$

It is to be noted that the meaning of each reference numeral is as follows.

X: distance from point with height h from optical axis on aspherical surface to tangential plane at vertex of aspherical surface

h: height from optical axis (distance in lateral direction in FIG. 2)

Cj: curvature at vertex of aspherical surface of jth surface of objective lens (Cj=1/Rj)

Kj: conic constant of jth surface of objective lens

Aj,n: nth-order aspherical coefficient of jth surface of objective lens where j=1, 2

### Example 1

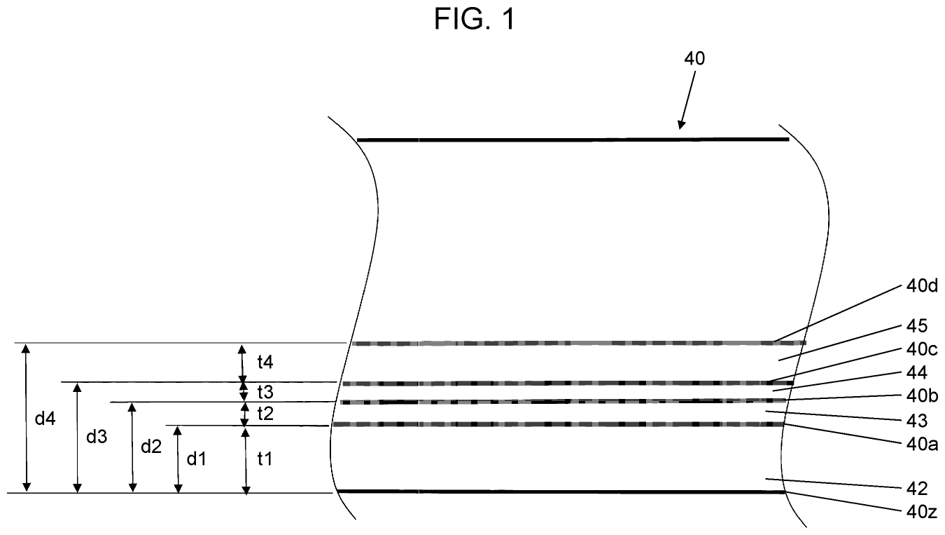

The present example shows an objective lens corresponding to a four-layer optical disk having standard values as follows in FIG. 1: t1=46 (μm), t2=14 (μm), t3=22 (μm), and t4=18 (μm). Since the standard value of the base material thickness (d1 to d4) ranges from 46 μm to 100 μm, the average value thereof is 73 μm.

Specific numerical values of the objective lens of Example 1 are shown below. Example 1 is an example in which a single lens having a refractive index n of a glass material of 1.6239179286, a focal length f of 1.310, a numerical aperture NA of 0.92, and a working distance Wd of 0.2603 is designed.

f=1.310

NA=0.92

R1=0.94914648

R2=−1.3904864

d=1.8864562

n=1.6239179286

Wd=0.2603

K1=−0.61235467

A1,4=0.032559077

A1,6=−055916593

A1,8=0.29336836

A1,10=−0.57792146

A1,12=0.39248980

A1,14=0.47987226

A1,16=−0.94526819

A1,18=0.39272824

A1,20=−0.034749112

A1,22=0.356603999

A1,24=−0.31438861

A1,26=−0.14056863

A1,28=0.24740123

A1,30=−0.083558657

A1,32=0.0049478558

A1,34=−0.00016143088

A1,36=−0.00022107185

A1,38=−0.000051205268

A1,40=0.00016909200

K2=−34.615191

A2,4=1.5669936

A2,6=−9.1540096

A2,8=32.319289

A2,10=−71.473950

A2,12=77.578476

A2,14=26.924457

A2,16=−196.43080

A2,18=233.52641

A2,20=−94.340941

A2,22=−4.5551101

A2,24=−15.293308

A2,26=16.666311

A2,28=3.3677085

A2,30=6.2658324

A2,32=−2.0560474

A2,34=−0.040157121

A2,36=−5.1751801

A2,38=−9.5649736

A2,40=10.077867

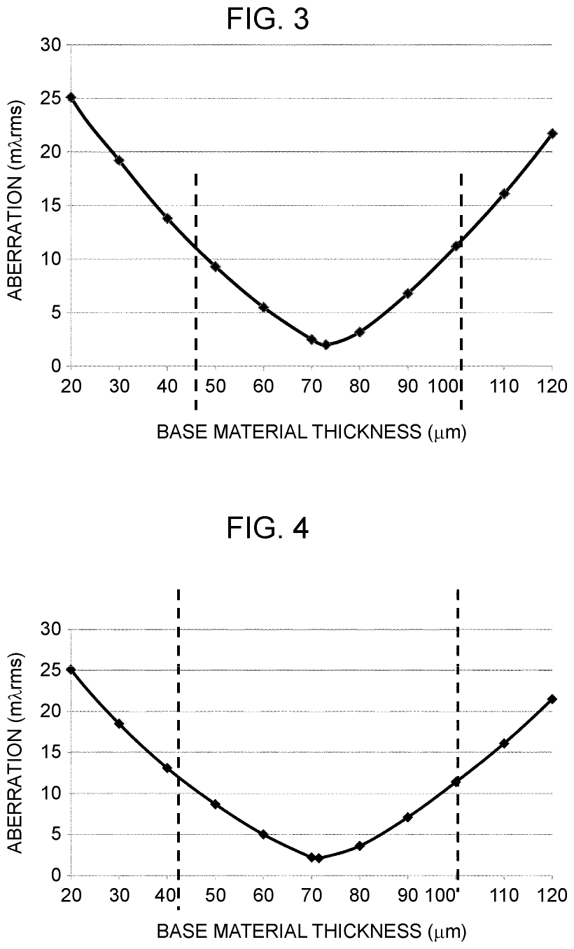

FIG. 3 is a characteristic diagram of the objective lens of the present example. The horizontal axis represents a thickness of a transparent base material from the optical disk surface to the information recording and reproducing surface, that is, the base material thickness. The vertical axis represents wavefront aberration of a convergent spot. The degree of convergence of the light beam input to the objective lens is adjusted such that the aberration represented by the vertical axis is minimized according to the base material thickness represented by the horizontal axis.

Third-order spherical aberration is minimized when a substantially parallel light beam is input to the objective lens of the present example and passed through the base material thickness of about 80 μm. On the other hand, the feature of the present application is to design such that total aberration including higher-order aberrations are minimized when a light beam that slightly converge is input to the objective lens and passed through a base material thickness of 73 μm. As illustrated in FIG. 3, the residual aberration falls below 12 mλ (that is an rms value, and λ is a wavelength and NA is 0.91) at a smaller base material thickness, for example, 46 μm. On a larger base material thickness side, only 12 mλ or less of aberration remains at 100 μm, which means well-balanced state is achieved. It is possible to ensure a margin of aberration against a manufacturing error, a parallelism adjustment error of incident light, and the like.

The largest component of the residual aberration is the fifth-order spherical aberration. Therefore, the feature of the present application is also to design such that the base material thickness at which the third-order spherical aberration is minimized when a substantially parallel light beam is input to the objective lens is different from the base material thickness at which the fifth-order spherical aberration is minimized when the third-order spherical aberration is minimized by changing the parallelism of the light beam input to the objective lens from the parallel state. In the present example, the base material thickness at which the third-order spherical aberration is minimized when a substantially parallel light beam is input to the objective lens is 80 μm, and the base material thickness at which the fifth-order spherical aberration is minimized when the third-order spherical aberration is minimized by changing the parallelism of the light beam input to the objective lens from the parallel state is about 73 μm. In a state where the fifth-order spherical aberration is minimized, the light beam incident on the objective lens is slightly convergent.

When a substantially parallel light beam is input to the objective lens according to the present application and passed through a base material thickness of about 80 μm, the third-order spherical aberration is minimized, and the higher-order spherical aberration including the fifth-order spherical aberration is also less than 5 mλ. Therefore, the aberration can be accurately inspected by setting the total aberration or the fifth-order spherical aberration as a reference value and determining a difference from the reference value as an inspection reference value of aberration. That is, the aberration can be accurately inspected by measuring the aberration when the substantially parallel light beam is input to the objective lens and passed through a fixed base material thickness, and determining the condition that the difference between the total aberration and the refence value, or the difference between the fifth-order spherical aberration that is the measurement result and the reference value falls within a fixed range as a condition for a good product.

Therefore, it is possible to obtain a remarkable effect of simultaneously satisfying two kinds of conditions: the condition of being adapted to a smaller base material thickness, and the condition of measurement under the condition same as that for the conventional objective lens.

If the objective lens is designed such that, when a substantially parallel light beam is input to the objective lens, the total aberration is minimized at the base material thickness of 73 μm, aberration of 75 mλ (rms value) or more is generated at the base material thickness of 80 μm within a range of a numerical aperture of 0.91 when a substantially parallel light beam is input to the objective lens, and the aberration cannot be measured with high accuracy. It is found from comparison to this example that the effect of the present invention is significant.

In addition, an objective lens for an optical disk often uses an aperture limit in order to use a designed numerical aperture NA. For example, in FIG. 1, the diameter of the light flux of light beam 107 to objective lens 100 is adjusted to a desired value by providing an aperture limit or a diaphragm (not illustrated) on the incidence side (lower side in FIG. 1) of objective lens 100 where the substantially parallel light beam enters, in order to achieve an accurate numerical aperture NA. When doing so, there may be an error in the positional relationship between the diaphragm and objective lens 100 with respect to the designed value, and a tolerance is required. It is only sufficient that such a tolerance is 20 μm. In order to allow the tolerance of 20 μm in horizontal direction and front-rear direction for the objective lens having a focal length of about 1 mm in FIG. 1, it is desirable to extend the lens to increase the numerical aperture by about 0.02 because of 0.02 mm÷NA≈0.02, so as to reduce at least the axial aberration. In the present example, it is also predicted that the aspherical surface is extended to increase the NA to 0.94 (0.92+0.02=0.94) so as to reduce the axial aberration, and when the objective lens is mounted on an optical pickup, the NA is limited to 0.9 to 0.92 with a diaphragm (aperture).

### Example 2

The present example shows an objective lens corresponding to an optical disk having standard values as follows in FIG. 1: t1=43 (μm), t2=19 (μm), t3=15 (μm), and t4=23 (μm). Since the standard value of the base material thickness ranges from 43 μm to 100 μm, the average value thereof is 71.5 μm.

Example 1 shows a single lens having a refractive index n of a glass material of 1.6239179286, a numerical aperture NA of 0.92, and a working distance Wd of 0.2603. The focal length f is 1.31052.

NA=0.92

R1=0.94932135

R2=−1.3922442

d=1.8873592

n=1.6239179286

Wd=0.2603

K1=−0.61232519

A1,4=0.03265204

A1,6=−0.05999135

A1,8=0.29352737

A1,10=−0.57804149

A1,12=0.39250540

A1,14=0.47988186

A1,16=−0.94521185

A1,18=0.39272473

A1,20=−0.034758187

A1,22=0.35658655

A1,24=−0.31439476

A1,26=−0.14056305

A1,28=0.24740927

A1,30=−0.083557218

A1,32=0.0049445696

A1,34=−0.00016176460

A1,36=−0.00022157979

A1,38=−0.000050986197

A1,40=0.00016926398

K2=−34.965455

A2,4=1.5666847

A2,6=−9.1558998

A2,8=32.319013

A2,10=−71.471494

A2,12=77.584089

A2,14=26.925612

A2,16=−196.44056

A2,18=233.51653

A2,20=−94.344153

A2,22=−4.5521940

A2,24=−15.272508

A2,26=16.691023

A2,28=3.3801034

A2,30=6.2370814

A2,32=−2.1114694

A2,34=−0.025926053

A2,36=−5.1920593

A2,38=−9.5406082

A2,40=0.102341

FIG. 4 is a characteristic diagram of the objective lens of the present example. The horizontal axis represents a thickness of a transparent base material from the optical disk surface to the information recording and reproducing surface, that is, the base material thickness. The vertical axis represents wavefront aberration of a convergent spot. The degree of convergence of the light beam input to the objective lens is adjusted such that the aberration represented by the vertical axis is minimized according to the base material thickness represented by the horizontal axis.

Third-order spherical aberration is minimized when a substantially parallel light beam is input to the objective lens of the present example and passed through the base material thickness of about 80 μm. However, a feature of the present application is to design such that the total aberration including the higher-order aberrations is minimized when a light beam that slightly converges is input to the objective lens and passed through a base material thickness of 71.5 μm. As illustrated in FIG. 4, the residual aberration is about 12 mλ (which is an rms value, and λ is a wavelength and NA is 0.91) at a smaller base material thickness, for example, 43 μm. On a larger base material thickness side, only about 12 mλ of aberration remains at 100 μm, which means well-balanced state is achieved. It is possible to ensure a margin of aberration against a manufacturing error, a parallelism adjustment error of incident light, and the like.

The largest component of the residual aberration is the fifth-order spherical aberration. Therefore, the feature of the present application is also to design such that the base material thickness at which the third-order spherical aberration is minimized when a substantially parallel light beam is input to the objective lens is different from the base material thickness at which the fifth-order spherical aberration is minimized when the third-order spherical aberration is minimized by changing the parallelism of the light beam input to the objective lens from the parallel state. In the present example, the base material thickness at which the third-order spherical aberration is minimized when a substantially parallel light beam is input to the objective lens is 80 μm, and the base material thickness at which the fifth-order spherical aberration is minimized when the third-order spherical aberration is minimized by changing the parallelism of the light beam input to the objective lens from the parallel state is about 71.5 μm. In a state where the fifth-order spherical aberration is minimized, the light beam incident on the objective lens is slightly convergent.

When a substantially parallel light beam is input to the objective lens according to the present application and passed through a base material thickness of about 80 μm, the third-order spherical aberration is minimized, and the higher-order spherical aberration including the fifth-order spherical aberration is also less than 5 mλ. Therefore, the aberration can be accurately inspected by setting the total aberration or the fifth-order spherical aberration as a reference value and determining a difference from the reference value as an inspection reference value of aberration. That is, the aberration can be accurately inspected by measuring the aberration when the substantially parallel light beam is input to the objective lens and passed through a fixed base material thickness, and determining the condition that the difference between the total aberration and the refence value, or the difference between the fifth-order spherical aberration that is the measurement result and the reference value falls within a fixed range as a condition for a good product.

Therefore, it is possible to obtain a remarkable effect of simultaneously satisfying two kinds of conditions: the condition of being adapted to a smaller base material thickness, and the condition of measurement under the condition same as that for the conventional objective lens.

If the objective lens is designed such that, when a substantially parallel light beam is input to the objective lens, the total aberration is minimized at the base material thickness of 71.5 μm, aberration of 90 mλ (rms value) or more is generated at the base material thickness of 80 μm within a range of a numerical aperture of 0.91 when a substantially parallel light beam is input to the objective lens, and the aberration cannot be measured with high accuracy. It is found from comparison to this example that the effect of the present invention is significant.

In the present example, it is also predicted that the aspherical surface is extended to increase the NA to about 0.94 so as to reduce the axial aberration, and when the objective lens is mounted on an optical pickup, the NA is limited to 0.9 to 0.92 with a diaphragm (aperture limit or aperture).

### Second Exemplary Embodiment

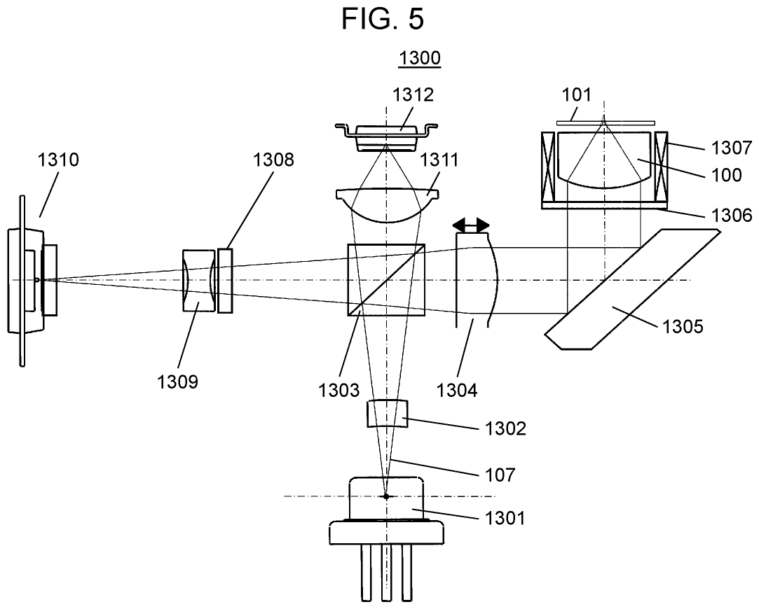

FIG. 5 is a diagram illustrating a configuration of optical head device 1300 according to a second exemplary embodiment. In FIG. 5, optical head device 1300 includes laser light source 1301, relay lens 1302, beam splitter 1303, collimator lens (first convex lens) 1304, raising mirror 1305, quarter wavelength plate 1306, objective lens 100, driver 1307, diffraction element 1308, detection lens 1309, first photodetector 1310, condenser lens 1311, and second photodetector 1312. Optical disk 101 has base material thickness t1 of about 0.1 mm (base material thickness of 0.11 mm or less including a manufacturing error is regarded as about 0.1 mm) or a smaller base material thickness, and information is recorded on and reproduced from optical disk 101 by a light beam having wavelength λ1. Laser light source 1301 emits light beam 107 of blue light having wavelength λ1 (390 nm to 415 nm: typically about 405 nm). For example, as illustrated in FIG. 1, optical disk 101 has, in addition to base material 105 from a light incidence surface to a recording surface, substrate (protective material) 104 with a thickness of about 1.1 mm which is bonded to base material 105 in order to increase mechanical strength. Thus, optical disk 101 has an outer shape with a thickness of about 1.2 mm. The substrate is not illustrated in the drawings of the present invention to be referred to below for simplicity.

Laser light source 1301 is preferably a semiconductor laser light source. With this configuration, the optical head device and an optical information apparatus using the optical head device can be reduced in size, weight, and power consumption.

When information is recorded on or reproduced from optical disk 101, light beam 107 having wavelength λ1 emitted from laser light source 1301 is reflected by beam splitter 1303 via relay lens 1302, and is converted into a substantially parallel light beam by collimator lens 1304. Then, the optical axis of the resultant light beam is further bent by raising mirror 1305, and the resultant light beam is circularly polarized by quarter wavelength plate 1306. Light beam 107 is converged on information recording surface 106 through the base material having a thickness of about 0.1 mm of optical disk 101 by objective lens 100. Relay lens 1302 can set the light use efficiency and far field pattern from laser light source 1301 to be preferable, but can be omitted if not particularly necessary. Here, raising mirror 1305 is illustrated such that it bends the light beam upward in the page for the sake of convenience of drawings, but in practice, raising mirror 1305 is configured to bend the optical axis of the light beam in a direction out of page or into page so as to be perpendicular to the page. The optical path described above is referred to as a forward path.

Light beam 107 reflected on the information recording surface travels back through the original optical path (return path), is converted into linearly polarized light in a direction perpendicular to the initial direction by quarter wavelength plate 1306, approximately totally transmits through beam splitter 1303, and enters first photodetector 1310 with the focal length being extended by detection lens 1309. A servo signal and an information signal used for focus control and tracking control are obtained by computing the output of first photodetector 1310. Note that it is also possible to achieve highly accurate and stable servo signal detection by providing diffraction element 1308 in the return path. As described above, beam splitter 1303 includes a polarization separation film that, regarding light beam 107 having wavelength Xl, totally reflects linearly polarized light in one direction and totally transmits linearly polarized light in a direction perpendicular thereto. Note that, depending on the application of optical head device 1300 such as an application to a playback-only machine, the polarization dependency of beam splitter 1303 can be eliminated, and quarter wavelength plate 1306 can be omitted.

Here, objective lens 100 is the objective lens according to the first exemplary embodiment. Specifically, the aberration of objective lens 100 can be inspected using a base material common to the conventional objective lens, and objective lens 100 can be manufactured at low cost. Therefore, optical head device 1300 provides an effect of being adapted to a smaller base material thickness, so that it is possible to record and reproduce information on and from a multilayer optical disk, and capable of being manufactured at low cost.

Further, collimator lens 1304 is moved in the optical axis direction (horizontal direction in FIG. 5) to change the parallelism of the light beam. Spherical aberration occurs when there is a thickness error of the base material or a base material thickness caused by a thickness between layers in a case where optical disk 101 is a multilayer disk. However, such spherical aberration can be corrected by moving collimator lens 1304 in the optical axis direction in this manner. The base material thickness of ±30 μm or more can also be corrected by the correction of the spherical aberration by moving collimator lens 1304 as described above.

Furthermore, when beam splitter 1303 is configured to transmit a part (for example, about 10%) of the linearly polarized light emitted from laser light source 1301, and transmitted light beam 107 is further guided to second photodetector 1312 by condenser lens 1311, a change in the amount of emitted light of light beam 107 can be monitored using a signal obtained from second photodetector 1312, or the change in the amount of light can be fed back to perform control to keep the amount of emitted light of light beam 107 constant.

### Third Exemplary Embodiment

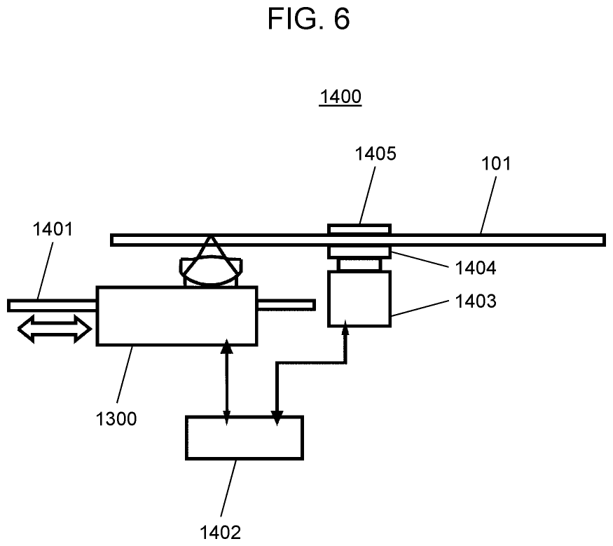

FIG. 6 is a diagram illustrating the configuration of optical information apparatus 1400 according to a third exemplary embodiment. In FIG. 6, optical information apparatus 1400 includes optical head device 1300, drive device 1401, electric circuit 1402, motor 1403, turntable 1404, and clamper 1405. Optical head device 1300 is the optical head device described in the second exemplary embodiment.

Optical disk 101 is mounted on turntable 1404, and is rotated by motor 1403 while being fixed by damper 1405. Optical head device 1300 is coarsely moved by drive device 1401 up to a track of optical disk 101 that contains desired information.

Optical head device 1300 transmits a focus error (focal error) signal and a tracking error signal to electric circuit 1402 according to a positional relationship with optical disk 101. In response to this signal, electric circuit 1402 transmits a signal for slightly moving objective lens 100 to optical head device 1300. With this signal, optical head device 1300 performs focus control and tracking control on optical disk 101, and information is read or written (recorded) by optical head device 1300.

Optical information apparatus 1400 according to the present exemplary embodiment uses optical head device 1300 described in the second exemplary embodiment as the optical head device. Thus, optical information apparatus 1400 has an effect that it can be manufactured at low cost and can be adapted to a large-capacity multilayer optical disk.

### Fourth Exemplary Embodiment

A computer, an optical disk player, an optical disk recorder, a server, a vehicle, and the like including optical information apparatus 1400 described in the third exemplary embodiment or adopting the recording and reproducing method described above can stably record or reproduce information on or from different types of optical disks, and therefore can be widely used for various purposes. In addition, since the abovementioned products are common regarding reproducing information from the optical disk using the optical head device, they can be collectively referred to as an optical disk system.

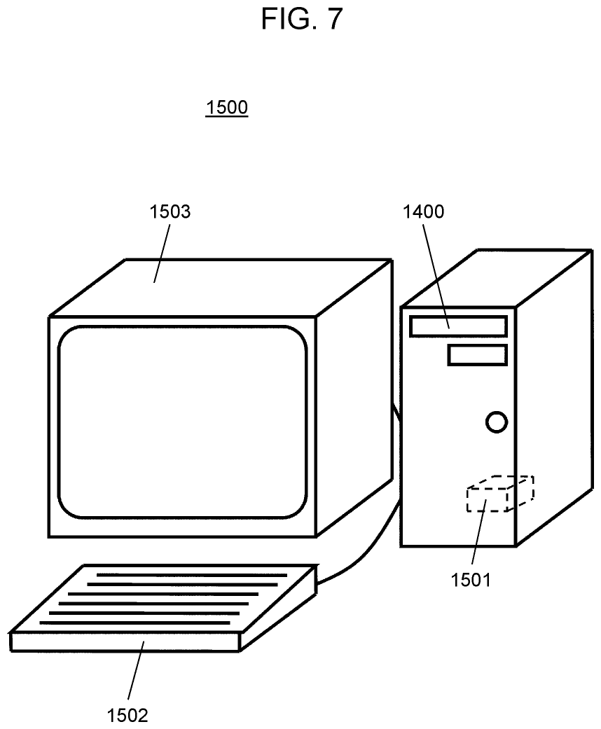

FIG. 7 is a diagram illustrating a configuration of optical disk system 1500 according to a fourth exemplary embodiment of the present invention. Optical disk system 1500 includes optical information apparatus 1400 described in the third exemplary embodiment and computing device 1501. Optical disk system 1500 includes an input terminal to which input device 1502 is connected and an output terminal to which output device 1503 is connected.

Input device 1502 inputs information. For example, a keyboard, a mouse, or a touch panel is an example of input device 1502. Computing device 1501 performs computation on the basis of information input from input device 1502, information read from optical information apparatus 1400, and the like. For example, a central processing unit (CPU) is an example of computing device 1501. Output device 1503 displays information such as a result computed by computing device 1501. For example, a cathode ray tube, a liquid crystal display device, and a printer are examples of output device 1503.

The optical disk system according to the present exemplary embodiment uses the optical head device described in the third exemplary embodiment as the optical head device. Thus, the optical disk system has an effect that it can be manufactured at low cost and can construct a large-capacity system using a large-capacity multilayer optical disk.

Note that computing device 1501 may be a conversion device that converts an information signal obtained from optical information apparatus 1400 into an image including a still image or a moving image. Furthermore, computing device 1501 may be a conversion device that converts an image including a still image or a moving image obtained from optical information apparatus 1400 into information. In addition, it may be a conversion device capable of converting an information signal obtained from optical information apparatus 1400 into an image including a still image or a moving image, and converting an image including a still image or a moving image obtained from optical information apparatus 1400 into information. In addition, input device 1502 and output device 1503 may be integrated with optical disk system 1500.

### Fifth Exemplary Embodiment

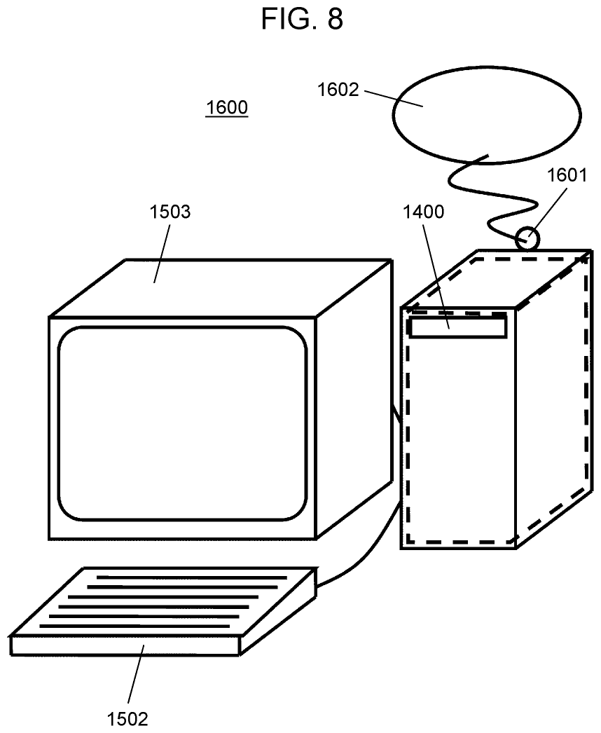

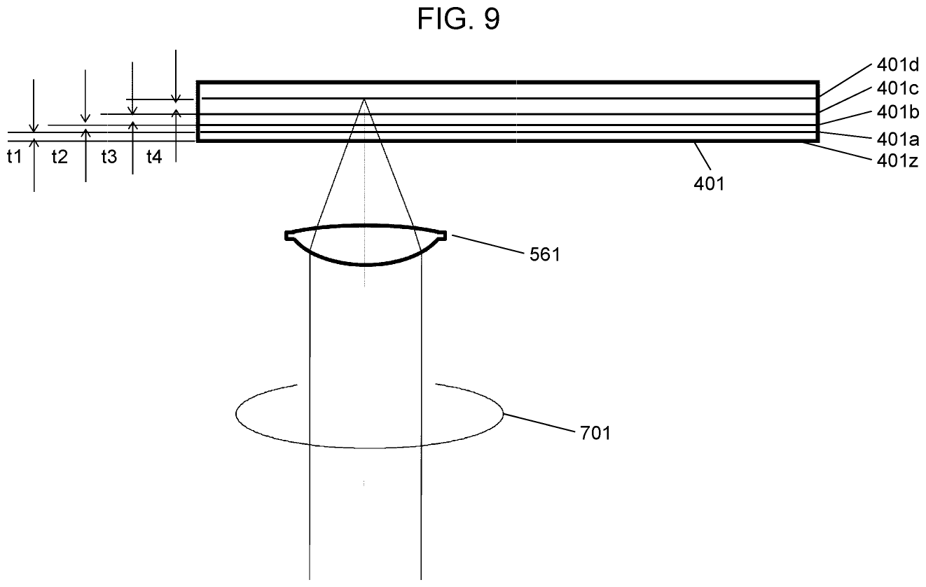

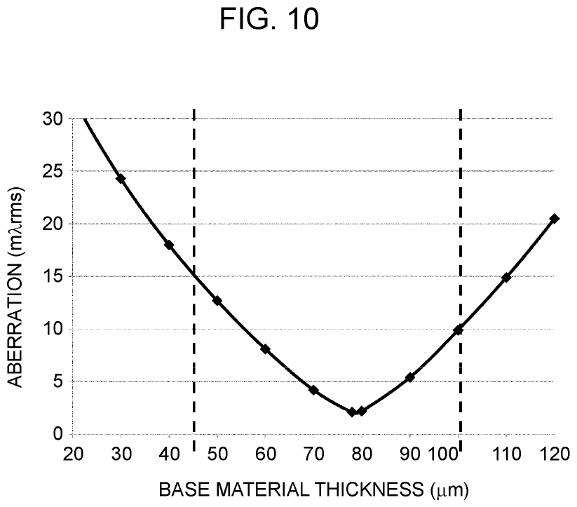

FIG. 8 is a diagram illustrating a configuration of optical disk system 1600 according to a fifth exemplary embodiment of the present invention. Optical disk system 1600 is constructed by adding input and output terminal 1601 to optical disk system 1500 according to the third exemplary embodiment. Input and output terminal 1601 is a wired or wireless communication terminal that captures information to be recorded in optical information apparatus 1400 and outputs information read by optical information apparatus 1400 to external network 1602. Thus, information can be exchanged with a network, that is, a plurality of devices such as a computer, a telephone, and a television tuner, and optical disk system 1600 can be used as an information server shared by the plurality of devices. Since the optical information apparatus according to the fifth exemplary embodiment can stably record or reproduce information on or from different types of optical disks, it is effectively used for various purposes. Furthermore, output device 1503 such as a cathode ray tube, a liquid crystal display device, or a printer that displays information may be provided.

In addition, the optical disk system may be provided with a changer that can load and unload a plurality of optical disks to and from optical information apparatus 1400. With this configuration, more information can be recorded and stored, whereby the optical disk system is suitable as an information storage device in a data center.

The optical information apparatus according to the present exemplary embodiment uses the abovementioned optical head device according to the present invention as the optical head device. Thus, the optical information apparatus can be manufactured at low cost, and can construct a large-capacity system using a large-capacity multilayer optical disk.

Note that, although in the fourth and fifth exemplary embodiments, output device 1503 is illustrated in FIGS. 15 and 16, it is obvious that a mode in which an output terminal is provided, and output device 1503 is not provided but is sold separately is possible. Further, in the fourth and fifth exemplary embodiments, a mode in which only an input terminal is provided and an input device is sold separately is also possible.

### INDUSTRIAL APPLICABILITY

The objective lens and the optical head device according to the present invention can be manufactured at low cost, and can be adapted to a large-capacity multilayer optical disk. Furthermore, the optical information apparatus using the optical head device can be manufactured at low cost, and can construct a large-capacity system using a large-capacity multilayer optical disk. In addition, the present invention is expected to be applicable to any system that stores information, such as a computer, an optical disk player, an optical disk recorder, a car navigation system, an editing system, a data server, an AV component, and a vehicle.

### REFERENCE MARKS IN THE DRAWINGS

40: optical disk
40a: first information recording surface
40b: second information recording surface
40c: third information recording surface
40d: fourth information recording surface
100: objective lens
101: optical disk
102: first surface
103: second surface
104: substrate
105: base material
106: information recording surface
107: light beam
401: optical disk
561: objective lens
701: light beam
1300: optical head device
1301: laser light source
1302: relay lens
1303: beam splitter
1304: collimator lens
1305: raising mirror
1306: quarter wavelength plate
1307: driver
1308: diffraction element
1309: detection lens
1310: first photodetector
1311: condenser lens
1312: second photodetector
1400: optical information apparatus
1401: drive device
1402: electric circuit
1403: motor
1404: turntable
1405: clamper
1500: optical disk system
1501: computing device
1502: input device
1503: output device
1600: optical disk system
1601: input and output terminal
1602: external network

1. An objective lens having a single lens that has a numerical aperture of 0.85 or more,
wherein a base material thickness th and a base material thickness tm differ from each other,
the base material thickness th is a thickness where third-order spherical aberration is minimized when a light beam that is substantially parallel is input to the objective lens, and
the base material thickness tm is a thickness where total aberration is minimized when third-order spherical aberration is minimized by changing parallelism of the light beam input to the objective lens from a parallel state.

2. The objective lens according to claim 1, wherein the base material thickness th is larger than the base material thickness tm.

3. The objective lens according to claim 2, wherein the base material thickness th is larger than 75 μm, and the base material thickness tm is smaller than 75 μm.

4. An objective lens having a single lens that has a numerical aperture of 0.85 or more,
wherein a base material thickness th and a base material thickness tm5 differ from each other,
the base material thickness th is a thickness where third-order spherical aberration is minimized when a light beam that is substantially parallel is input to the objective lens, and
the base material thickness tm5 is a thickness where fifth-order spherical aberration is minimized when third-order spherical aberration is minimized by changing parallelism of the light beam input to the objective lens from a parallel state.

5. The objective lens according to claim 4, wherein the base material thickness th is larger than the base material thickness tm5.

6. The objective lens according to claim 5, wherein the base material thickness th is larger than 75 μm, and the base material thickness tm5 is smaller than 75 μm.

7. The objective lens according to claim 1, wherein the numerical aperture is 0.9 or more.

8. An optical head device comprising:
a laser light source that emits a light beam;
the objective lens according to claim 1 that receives the light beam emitted from the laser light source and focuses the light beam on a micro spot on a recording surface of an optical disk; and
a photodetector provided with an optical detector that receives the light beam reflected on the recording surface of the optical disk and outputs an electric signal in accordance with an amount of the reflected light beam.

9. An optical information apparatus comprising:
the optical head device according to claim 8;
a motor that rotates the optical disk; and
an electric circuit that receives a signal obtained from the optical head device and controls and drives the motor, the objective lens, and the laser light source.

10. An optical information apparatus comprising:
an optical head device;
a motor that rotates an optical disk; and
an electric circuit that receives a signal obtained from the optical head device and controls and drives the motor, the objective lens according to claim 1, and a laser light source,
wherein
the optical head device includes:
a first light source,
the objective lens that receives a light beam emitted from the first light source and focuses the light beam on a micro spot on a recording surface of the optical disk through a base material with base material thickness t1,
a photodetector provided with an optical detector that receives the light beam reflected on the recording surface of the optical disk and outputs an electric signal in accordance with an amount of the reflected light beam, and
an actuator that drives the objective lens in an optical axis direction to bring the micro spot into focus on the recording surface of the optical disk,
the optical head device detects an electric signal for detecting a focal error signal from the photodetector, and
the optical head device drives the objective lens in the optical axis direction by the actuator to bring the micro spot into focus on the recording surface of the optical disk.

11. An optical disk system comprising:
the optical information apparatus according to claim 9;
an input device or input terminal for inputting information;
a computing device that performs computation based on information input from the input device or input terminal or information reproduced from the optical information apparatus; and
an output device or output terminal that displays or outputs the information input from the input device or input terminal, the information reproduced from the optical information apparatus, or a result computed by the computing device.

12. An optical disk system comprising:
the optical information apparatus according to claim 9; and
an information-to-image decoder that converts an information signal obtained from the optical information apparatus into an image.

13. An optical disk system comprising:
the optical information apparatus according to claim 9; and
an image-to-information encoder that converts an image information obtained from the optical information apparatus into information to be recorded.

14. An optical disk system comprising:
the optical information apparatus according to claim 9; and
an input and output terminal that exchanges information with an outside.

15. A method of inspecting an objective lens, the method comprising:
measuring aberration when a light beam that is substantially parallel is input to the objective lens and passed through a fixed base material thickness; and
determining a condition that a difference between total aberration and a refence value, or a difference between fifth-order spherical aberration and the refence value falls within a fixed range, as a condition for a good product.

16. A method of inspecting the objective lens according to claim 1, the method comprising:
measuring aberration when a light beam that is substantially parallel is input to the objective lens and passed through a fixed base material thickness; and
determining a condition that a difference between total aberration and a refence value, or a difference between fifth-order spherical aberration and the refence value falls within a fixed range, as a condition for a good product.
